(19) United States
(12) Patent Application Publication
(10) Pub. No.: US 2026/0307684 A1
(43) Pub. Date: Oct. 8, 2026

(54) APPARATUS FOR CONTROLLING VEHICLE AND METHOD THEREOF

(71) Applicants: Hyundai Motor Company, Seoul (KR); Kia Corporation, Seoul (KR)

(72) Inventors: Hyeon Jun LIM, Hwaseong-Si (KR); Min Kyun YOO, Hwaseong-Si (KR); Nam Gyun KIM, Hwaseong-Si (KR); Mu Gwan JEONG, Hwaseong-Si (KR); Jong Won PARK, Hwaseong-Si (KR); Jin Hak KIM, Hwaseong-Si (KR); Hyun Ju KIM, Hwaseong-Si (KR)

(21) Appl. No.: 19/391,095

(22) Filed: Nov. 17, 2025

(30) Foreign Application Priority Data
Apr. 7, 2025 (KR) 10-2025-0044855

(51) Int. Cl. B60W 60/00; G01S 7/497; G01S 17/89; G01S 17/931; G06T 7/11; G06T 7/73

(52) U.S. Cl. CPC B60W 60/0027; G01S 7/497; G01S 17/89; G01S 17/931; G06T 7/11; G06T 7/73; B60W 2420/408; B60W 2554/4041; G06T 2207/10028; G06T 2207/20084

(57) ABSTRACT

An apparatus of a vehicle may comprise a sensor configured to, based on a pulsed laser signal emitted from the sensor, obtain a plurality of points associated with surroundings of the vehicle, a memory configured to store a first neural network model for detecting an object and a second neural network model for outputting types of the plurality of points and scores of the plurality of points, and a processor circuit. The processor circuit may obtain a first virtual box or a first class, obtain first partial points or a second class, output a signal indicating a bounding box corresponding to a target object, and control, based on the bounding box, autonomous driving of the vehicle.

### CROSS-REFERENCE TO RELATED APPLICATION

This application claims the benefit of priority to Korean Patent Application No. 10-2025-0044855, filed in the Korean Intellectual Property Office on Apr. 7, 2025, the entire contents of which are incorporated herein by reference.

### TECHNICAL FIELD

The present disclosure relates to a vehicle control apparatus and a method thereof, and more particularly, relates to a technology for using light detection and ranging (LiDAR).

### BACKGROUND

The matters described in this Background section are only for enhancement of understanding of the background of the disclosure, and should not be taken as acknowledgment that they correspond to prior art already known to those skilled in the art.

When a vehicle is operating in autonomous and/or assisted driving modes, various sensors (e.g., LiDAR, cameras, and/or RADAR) may be used. The vehicle may recognize driving environments by using various sensors and/or artificial intelligence (AI), may plan a route, and may drive along a route. The vehicle is expected to reduce traffic accidents, alleviate traffic congestion, improve mobility, and/or increase energy efficiency by operating in autonomous and/or assisted driving modes.

The vehicle may have challenging issues such as the fusion of sensors and data, real-time processing, decision-making, safety, and/or reliability, and thus various studies are being conducted on these issues.

### SUMMARY

The present disclosure was made to solve the above-mentioned problems.

According to the present disclosure, an apparatus of a vehicle may comprise a sensor configured to, based on a pulsed laser signal emitted from the sensor, obtain a plurality of points associated with surroundings of the vehicle, a memory configured to store a first neural network model for detecting an object and a second neural network model for outputting types of the plurality of points and scores of the plurality of points, and a processor circuit. The processor circuit may be configured to, based on the plurality of points and the first neural network model, obtain at least one of a first virtual box for representing a target object in the surroundings of the vehicle or a first class for indicating a type of the target object, and based on the plurality of points and the second neural network model, obtain at least one of first partial points among the plurality of points, wherein the first partial points correspond to at least part of the target object, or a second class identified based on the first partial points, wherein the second class indicates the type of the target object. The processor circuit may be further configured to, based on at least one of the first virtual box, the first class, the first partial points, or the second class, output a signal indicating a bounding box, wherein the bounding box corresponds to the target object, and control, based on the bounding box, autonomous driving of the vehicle.

The apparatus may be configured such that the processor circuit, based on classifying a type of each of the plurality of points, classifies second partial points among the plurality of points, wherein the second partial points correspond to a preset type, and identifies, based on the classifying of the second partial points, the first partial points.

The apparatus may be configured such that the processor circuit, based on processing the plurality of points using the second neural network model, obtains a partial class for obtaining the second class, obtains a score of each of the plurality of points, and fuses the partial class, the score of each of the plurality of points, and the second partial points.

The apparatus may be configured such that the processor circuit obtains, based on the first partial points, a point cloud, and generates, based on the point cloud, a second virtual box, wherein the second virtual box is different from the first virtual box and represents the target object.

The apparatus may be configured such that the processor circuit, based on at least one of the first partial points or the point cloud, identifies at least one of a heading direction indicating a traveling direction of the target object, a location of the second virtual box in a virtual coordinate system, a size of the second virtual box, or the second class.

The apparatus may be configured such that the processor circuit, based on at least one of the first virtual box, the first class, a heading direction of the second virtual box, the location of the second virtual box, the size of the second virtual box, or the second class, obtains at least one of a heading direction of the bounding box, the location of the bounding box in the virtual coordinate system, or a third class indicating the type of the target object corresponding to the bounding box.

The apparatus may be configured such that the processor circuit assigns a first identifier to the second virtual box, wherein the second virtual box is tracked based on the first identifier.

The apparatus may be configured such that the processor circuit assigns a second identifier to the bounding box, wherein the second identifier corresponds to the first identifier.

The apparatus may be configured such that the processor circuit tracks the target object across a plurality of frames based on identifying a plurality of bounding boxes that include the bounding box assigned with the second identifier.

The apparatus may be configured such that the processor circuit includes at least one of a central processing unit (CPU), a graphics processing unit (GPU), or a neural processing unit (NPU).

The apparatus may be configured such that at least one of the GPU or the NPU obtains, based on the first neural network model, the first virtual box and the first class.

The apparatus may be configured such that at least one of the GPU or the NPU, based on the second neural network model, obtains a partial class for obtaining the second class and obtains a score of each of the plurality of points.

The apparatus may be configured such that the central processing circuit, based on classifying a type of each of the plurality of points, classifies second partial points among the plurality of points, wherein the second partial points correspond to a preset type.

The apparatus may be configured such that the processor circuit generates, based on the bounding box, odometry associated with the sensor, and calibrates, based on the odometry, the plurality of points.

The apparatus may be configured such that the processor circuit performs, based on the first partial points, online calibration of the plurality of points.

According to the present disclosure, a method performed by an apparatus of a vehicle may comprise obtaining, from a sensor, a plurality of points associated with surroundings of the vehicle, based on the plurality of points and a first neural network model, obtaining at least one of a first virtual box for representing a target object in the surroundings of the vehicle or a first class for indicating a type of the target object, and based on the plurality of points and a second neural network model, obtaining at least one of first partial points among the plurality of points, wherein the first partial points correspond to at least part of the target object, or a second class identified based on the first partial points, and wherein the second class indicates the type of the target object. The method may further comprise, based on at least one of the first virtual box, the first class, the first partial points, or the second class, outputting a signal indicating a bounding box, wherein the bounding box corresponds to the target object, and controlling, based on the signal, autonomous driving of the vehicle.

According to the present disclosure, a vehicle may comprise a sensor configured to obtain point cloud data representing surroundings of the vehicle, a memory configured to store a first neural network model and a second neural network model, a driving control circuit configured to control autonomous driving of the vehicle, and a processor circuit. The processor circuit may be configured to cause the vehicle to obtain, based on the point cloud data and the first neural network model, a first virtual box and a first class, wherein the first virtual box and the first class are associated with a target object, and obtain, based on the point cloud data and the second neural network model, first partial points and a second class, wherein the first partial points and the second class are associated with the target object, and wherein the first partial points correspond to at least part of the target object. The processor circuit may be further configured to generate a bounding box representing the target object based on at least one of the first virtual box, the first class, the first partial points, or the second class, track the bounding box across a plurality of frames of the point cloud data, calibrate the point cloud data based on the tracked bounding box and update the bounding box based on the calibrated point cloud data, output a signal indicating the updated bounding box, and control, via the driving control circuit and based on the signal, autonomous driving of the vehicle.

The vehicle may be configured such that the processor circuit causes the vehicle to perform, based on misalignment of the sensor, calibration of the point cloud data during operation of the vehicle in real time.

The vehicle may be configured such that the processor circuit causes the vehicle to distribute processing of the point cloud data among a plurality of processing circuits.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a block diagram associated with a vehicle control apparatus, according to an example of the present disclosure;

FIGS. 2A, 2B, 2C, and 2D show examples of block diagrams associated with a process of a vehicle control apparatus, according to an example of the present disclosure;

FIG. 3 shows an example of a block diagram related to a process of a vehicle control apparatus, according to an example of the present disclosure;

FIG. 4 shows an example of a block diagram related to a process of a vehicle control apparatus, according to an example of the present disclosure;

FIG. 5 shows an example of a flowchart associated with a vehicle control method, according to an example of the present disclosure; and

FIG. 6 shows an example computing system associated with a vehicle control apparatus or vehicle control method, according to an example of the present disclosure.

### DETAILED DESCRIPTION

Hereinafter, some examples of the present disclosure will be described in detail with reference to the accompanying drawings. In adding reference numerals to components of each drawing, it should be noted that the same components include the same reference numerals, although they are indicated on another drawing. Furthermore, in describing the examples of the present disclosure, detailed descriptions associated with well-known functions or configurations will be omitted when they may make subject matters of the present disclosure unnecessarily obscure.

In describing elements of an example of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms used herein, including technical or scientific terms, include the same meaning as commonly understood by one of ordinary skill in the technical field to which the present disclosure belongs. It will be understood that terms used herein should be interpreted as including a meaning that is consistent with their meaning in the context of the present disclosure and the relevant art and will not be interpreted in an idealized or overly formal sense unless expressly so defined herein.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., feature of real-time object detection, tracking, and calibration using sensor point cloud data) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., feature of real-time object detection, tracking, and calibration using sensor point cloud data) described herein. For example, when a target object is detected and tracked in real time from sensor point cloud data, the regenerative brake or engine brake may be activated to assist in deceleration while maintaining calibrated sensor accuracy to ensure the vehicle slows safely without overshooting the detected object. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., feature of real-time object detection, tracking, and calibration using sensor point cloud data) described herein. For example, when a pedestrian is detected and tracked in real time, a V2X module may be controlled to transmit a warning message to nearby vehicles, or when calibration drift is detected in the point cloud data, the communication device may be triggered to upload sensor status and object data to a remote server for cooperative perception.

Minimum risk maneuver (MRM) operation(s) may also be controlled, for example, based on one or more features (e.g., feature of real-time object detection, tracking, and calibration using sensor point cloud data) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time. For example, a minimum risk maneuver may be controlled by detecting and tracking nearby vehicles or pedestrians in real time from sensor point cloud data, while calibrating the sensors to maintain reliable object positions, so that the vehicle may safely decelerate, steer to the shoulder, or stop without collision.

Biased driving operation(s) may also be controlled, for example, based on one or more features (e.g., feature of real-time object detection, tracking, and calibration using sensor point cloud data) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc. For example, the biased driving operation may be controlled by shifting the vehicle farther from an object detected and tracked in real time from sensor point cloud data, while dynamically recalibrating the sensor inputs to maintain accuracy under road vibration or sensor misalignment.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., feature of real-time object detection, tracking, and calibration using sensor point cloud data) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.). For example, the feature of real-time object detection, tracking, and calibration may control sensors by adjusting a LIDAR scan rate, activating additional RADAR channels, or recalibrating camera orientation in response to detected misalignment or changes in tracking confidence.

An autonomous driving activation/deactivation operation may be controlled based on one or more features (e.g., feature of real-time object detection, tracking, and calibration using sensor point cloud data) described herein. In particular, a perception control apparatus may determine an object status for the vehicle surroundings from point cloud data (e.g., identifying objects, generating bounding boxes, assigning identifiers across frames, and calibrating sensor misalignment in real time) and gate autonomous driving accordingly. When the object status is normal (e.g., detected objects are within safe distance thresholds and consistently tracked across frames), autonomous driving may be enabled. When the object status is cautionary (e.g., an object is detected closer than a threshold, tracking confidence is marginal, or calibration drift is identified in a short time window), autonomous driving may be restricted (e.g., speed/acceleration limits, tighter route constraints, or reduced feature set), and a driver takeover request may be prepared. When the object status is critical (e.g., an object suddenly appears in the vehicle path, tracking confidence drops below a threshold across several frames, or calibration error exceeds a safety margin), autonomous driving may be deactivated and a minimal risk maneuver initiated (e.g., controlled deceleration, lane-keeping to shoulder, or safe stop, etc.), while issuing a warning that includes object identification information.

According to the present disclosure, a vehicle control apparatus may utilize light detection and ranging (LiDAR) data and neural network models to improve recognition and tracking of objects surrounding a vehicle. The apparatus may obtain point cloud data based on pulsed laser signals from LiDAR and may process the data using a first neural network model to generate a virtual box and a class that represent a target object. The apparatus may further apply a second neural network model to classify types of points and generate scores for the points, thereby obtaining partial points corresponding to the target object and refining the classification of the object. By combining results from object detection, segmentation, and ground separation processes, the apparatus may generate bounding boxes that accurately represent the size, location, and orientation of surrounding objects in a virtual coordinate system. The apparatus may track the bounding boxes across multiple frames by assigning identifiers and may recalibrate LiDAR data in real time to reduce sensor misalignment. In some examples, processing tasks may be distributed among one or more processors, such as a central processing unit, a graphics processing unit, or a neural processing unit, to increase efficiency. Accordingly, the apparatus may support safe and reliable vehicle control by continuously identifying, classifying, and tracking dynamic or static objects in the driving environment.

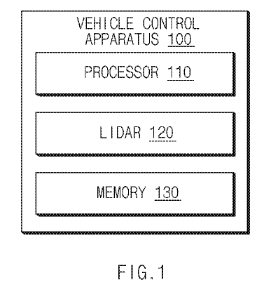

Hereinafter, various examples of the present disclosure will be described in detail with reference to FIGS. 1-6.

FIG. 1 shows an example of a block diagram associated with a vehicle control apparatus, according to an example of the present disclosure.

Referring to FIG. 1, a vehicle control apparatus 100 according to an example of the present disclosure may be implemented inside or outside a vehicle, and some of components included in the vehicle control apparatus 100 may be implemented inside or outside the vehicle. At this time, the vehicle control apparatus 100 may be integrated with internal control units of a vehicle and may be implemented with a separate device so as to be coupled with control units of the vehicle by means of a separate connection means. For example, the vehicle control apparatus 100 may further include components not shown in FIG. 1.

The vehicle control apparatus 100 according to an example may include a processor 110, a LiDAR 120, and a memory 130. The processor 110, the LiDAR 120, or the memory 130 may be electronically and/or operably coupled with each other by an electronical component including a communication bus.

Hereinafter, the fact that pieces of hardware are coupled operably may include the fact that a direct and/or indirect connection between pieces of hardware is established by wired and/or wirelessly such that second hardware is controlled by first hardware among the pieces of hardware.

Although different blocks are shown, an example is not limited thereto. For example, some of the pieces of hardware in FIG. 1 may be included in a single integrated circuit including a system on chip (SoC). The type and/or number of hardware included in the vehicle control apparatus 100 is not limited to that shown in FIG. 1. For example, the vehicle control apparatus 100 may include only some of the pieces of hardware shown in FIG. 1.

The vehicle control apparatus 100 according to an example may include hardware for processing data based on one or more instructions. For example, the hardware for processing data may include the processor 110. For example, the hardware for processing data may include an arithmetic and logic unit (ALU), a floating point unit (FPU), a field programmable gate array (FPGA), a central processing unit (CPU), and/or an application processor (AP). The processor 110 may include the architecture of a single-core processor, or may include the architecture of a multi-core processor including a dual core, a quad core, a hexa core, or an octa core (e.g., depending on the computational complexity of perception models, route planning, or control logic, etc.).

According to an example, the processor 110 may include at least one of a graphic processing unit (GPU), or a neural processing unit (NPU), or any combination thereof. For example, the GPU may be referred to as a “visual processing unit (VPU)”. For example, the NPU may be referred to as a “neural network processing unit”.

The vehicle control apparatus 100 according to an example may include a depth sensor for detecting an external object. For example, the depth sensor for detecting an external object may include at least one of a time of flight (ToF) sensor, the LiDAR 120, a structured light sensor, an ultrasonic sensor, an infrared sensor, radio detection and ranging (RADAR), or an optical distance sensor, or any combination thereof (e.g., combining LiDAR and RADAR to improve robustness in low-visibility conditions, etc.). Hereinafter, for convenience of description, descriptions will focus on LiDAR.

The vehicle control apparatus 100 according to an example may include the LiDAR 120 that obtains a plurality of points based on a pulse laser signal. For example, the LiDAR 120 may obtain datasets obtained by identifying objects surrounding the vehicle control apparatus 100 (or a vehicle including the vehicle control apparatus 100). For example, the LiDAR 120 may identify at least one of a location of the surrounding object, a movement direction of the surrounding object, or the speed of the surrounding object, or any combination thereof based on the pulse laser signal emitted from the LiDAR 120 being reflected and returned by the surrounding object (e.g., a nearby vehicle, a pedestrian, a tree, or a building, etc.).

For example, the LiDAR 120 may obtain datasets for expressing an external object in the space defined by an x-axis, a y-axis, and a z-axis based on a pulse laser signal reflected from surrounding objects. For example, the LiDAR 120 may obtain datasets including a plurality of points in the space, which is formed by the x-axis, the y-axis, and the z-axis, based on receiving the pulse laser signal at a designated period (e.g., every 100 milliseconds, every sensor frame, or at a refresh rate of 10 Hz, etc.). For example, the plurality of points may include points representing an external object within a three-dimensional virtual coordinate system. The three-dimensional virtual coordinate system may include at least one of a vehicle coordinate system, or a LiDAR coordinate system, or any combination thereof. However, an example of the three-dimensional virtual coordinate system is not limited to those described above (e.g., it may include a world coordinate system or a map-based coordinate system, etc.).

The memory 130 of the vehicle control apparatus 100 according to an example may include a hardware component for storing data and/or instructions that are to be input and/or output to the processor 110 of the vehicle control apparatus 100. For example, the memory 130 may include a volatile memory including a random-access memory (RAM), and/or a non-volatile memory including a read-only memory (ROM).

For example, the volatile memory may include at least one of a dynamic RAM (DRAM), a static RAM (SRAM), a cache RAM, or a pseudo SRAM (PSRAM), or any combination thereof.

For example, the non-volatile memory includes at least one of a programmable ROM (PROM), an erasable PROM (EPROM), an electrically erasable PROM (EEPROM), a flash memory, a hard disk, a compact disk, a solid state drive (SSD), or an embedded multi-media card (eMMC), or any combination thereof (e.g., depending on cost, size, write endurance, or access speed, etc.).

For example, one or more instructions indicating an arithmetic operation and/or an operation to be performed on data by the processor 110 of the vehicle control apparatus 100 may be stored in the memory 130 of the vehicle control apparatus 100. A set of one or more instructions may be referred to as a “program”, “firmware”, an “operating system”, a “process”, a “routine”, a “sub-routine”, and/or an “application” (e.g., an object detector, a SLAM module, or a LiDAR segmentation engine, etc.).

Hereinafter, the fact that an application is installed in the vehicle control apparatus 100 may mean that the one or more instructions provided in a form of an application are stored in the memory 130, and may mean that one or more applications are stored in a format (e.g., a file with an extension specified by the operating system of the vehicle control apparatus 100) executable by the processor 110 of the vehicle control apparatus 100 (e.g., a binary executable file, or a compiled library, etc.).

For example, the memory 130 may include a first neural network model for detecting an object. For example, the memory 130 may include a second neural network model for outputting the types of the plurality of points obtained by the LiDAR 120, and/or scores of the plurality of points (e.g., object class scores or distance likelihoods, etc.).

In an example, the processor 110 may obtain at least one of a first virtual box representing a target object, or a first class representing the type of the target object, or any combination thereof based on the plurality of points obtained through the LiDAR 120 and the first neural network model stored in the memory 130.

For example, the processor 110 may obtain at least one of the first virtual box representing the target object, or the first class representing the type of the target object, or any combination thereof based on inputting the plurality of points to the first neural network model. For example, the first neural network model may include an object detection model (e.g., a 3D bounding box detector or a center-based detection network, etc.).

For example, the target object may include an external object placed within a specified distance from the vehicle control apparatus 100 (or a host vehicle including the vehicle control apparatus 100) (e.g., within a 50-meter range in the forward direction, etc.). For example, the target object may include an object that is identified by the vehicle control apparatus 100 and is continuously tracked.

For example, the type of the target object may include a plurality of types for classifying the target object. For example, the type of the target object may include at least one of a first type representing the ground, or a second type representing a type different from the ground, or any combination thereof. The type of the target object is not limited to the examples described above. For example, the type of the target object may include, but is not limited to, at least one of a third type representing a person, or a fourth type representing a vehicle, or any combination thereof (e.g., a bicycle, a traffic cone, a tunnel wall, or a construction sign, etc.).

In an example, the processor 110 may obtain at least one of first partial points corresponding to at least part of the target object among the plurality of points, or a second class identified by the first partial points and representing the type of the target object, or any combination thereof based on the plurality of points and a second neural network model. For example, the second neural network model may include a segmentation model (e.g., a range-view CNN, a point-based classifier, or a sparse voxel network, etc.).

For example, the second neural network model may include a neural network model for obtaining the types of the plurality of points and scores of the plurality of points (e.g., softmax outputs, probability heatmaps, or class activation scores, etc.).

For example, the processor 110 may obtain the first partial points corresponding to at least part of the target object among the plurality of points based on inputting the plurality of points to the second neural network model. For example, the processor 110 may identify the types of the plurality of points based on inputting the plurality of points to the second neural network model. For example, the processor 110 may obtain the first partial points corresponding to at least part of the target object among the plurality of points based on the type of each of the plurality of points (e.g., classifying some points as belonging to a vehicle, pedestrian, or roadside object, etc.).

In an example, the processor 110 may perform a first specified algorithm on the plurality of points. For example, the processor 110 may perform the first specified algorithm for classifying the type of each of the plurality of points on the plurality of points, for example, within the LiDAR data frame. For example, the processor 110 may classify second partial points corresponding to a specified type among the plurality of points. For example, the specified type may include a type representing the ground (e.g., pavement, crosswalks, or flat surfaces, etc.).

For example, on the basis of performing the first specified algorithm on the plurality of points, the processor 110 may obtain (or identify) the first partial points by classifying the second partial points corresponding to the specified type and excluding the second partial points from the plurality of points (e.g., separating above-ground structures from terrain, etc.).

In an example, the processor 110 may obtain at least one of a partial class for obtaining the second class, or a score of each of the plurality of points, or any combination thereof based on inputting the plurality of points to the second neural network model. For example, the processor 110 may obtain the partial class and the score of each of the plurality of points based on inputting the plurality of points to the second neural network model. For example, the partial class may include classifying the plurality of points based on an arbitrary type (e.g., tree, vehicle, pedestrian, or unknown, etc.).

For example, the processor 110 may fuse the partial class, the score of each of the plurality of points, and the second partial points (e.g., for joint feature enhancement or confidence weighting, etc.). For example, the processor 110 may perform clustering based on fusing the partial class, the score of each of the plurality of points, and the second partial points. For example, the clustering may include grouping the first partial points corresponding to at least part of the target object (e.g., to generate an instance-level region for bounding box generation, etc.).

For example, the processor 110 may obtain a point cloud for generating a second virtual box based on the first partial points. For example, the processor 110 may obtain the point cloud based on grouping the first partial points (e.g., using spatial proximity, density thresholding, or Density-Based Spatial Clustering of Applications with Noise (DBSCAN), etc.).

For example, the processor 110 may generate the second virtual box, which is different from the first virtual box and represents the target object, based on the point cloud. For example, the second virtual box may include a box including at least some of the first partial points (e.g., tightly fitted to the object's spatial extent, etc.).

For example, the processor 110 may identify a heading direction indicating a traveling direction of the target object based on at least one of the first partial points, or the point cloud, or any combination thereof (e.g., using temporal point shifts or bounding box orientation, etc.).

For example, the processor 110 may identify the location of the second virtual box in the virtual coordinate system based on at least one of the first partial points, or the point cloud, or any combination thereof (e.g., by computing the centroid of the clustered points, using a bounding box anchor, or referencing vehicle-relative coordinates, etc.).

For example, the processor 110 may identify the size of the second virtual box based on at least one of the first partial points, or the point cloud, or any combination thereof (e.g., by estimating width, height, and depth based on point dispersion or statistical spread, etc.).

For example, the processor 110 may identify the second class based on at least one of the first partial points, or the point cloud, or any combination thereof (e.g., classifying as car, pedestrian, traffic cone, or unknown, etc.).

For example, the processor 110 may identify at least one of a heading direction indicating a traveling direction of the target object, a location of a second virtual box in a virtual coordinate system, a size of the second virtual box, or a second class, or any combination thereof based on at least one of the first partial points, or the point cloud, or any combination thereof (e.g., to aid in trajectory prediction, collision risk estimation, or classification confidence, etc.).

For example, the processor 110 may identify the heading direction of a bounding box based on at least one of the first virtual box, the first class, the heading direction of the second virtual box, the location of the second virtual box, the size of the second virtual box, or the second class, or any combination thereof (e.g., by tracking box orientation over time, using direction vectors, or aligning with lane markings, etc.).

For example, the processor 110 may identify the location of a bounding box in a virtual coordinate system based on at least one of the first virtual box, the first class, the heading direction of the second virtual box, the location of the second virtual box, the size of the second virtual box, or the second class, or any combination thereof (e.g., using Kalman filtering, relative coordinate mapping, or GPS reference data, etc.).

For example, the processor 110 may obtain a third class representing the type of the target object corresponding to the bounding box based on at least one of the first virtual box, the first class, the heading direction of the second virtual box, the location of the second virtual box, the size of the second virtual box, or the second class, or any combination thereof (e.g., refining classification using fusion from multiple frames, object hierarchy rules, or semantic context, etc.).

For example, the processor 110 may obtain at least one of the heading direction of the bounding box, the location of the bounding box in the virtual coordinate system, or the third class indicating the type of the target object corresponding to the bounding box, or any combination thereof based on at least one of the first virtual box, the first class, the heading direction of the second virtual box, the location of the second virtual box, the size of the second virtual box, or the second class, or any combination thereof (e.g., for generating object tracks, scene graphs, or vehicle control cues, etc.).

For example, the processor 110 may assign a first identifier to the second virtual box for tracking the second virtual box (e.g., a unique ID based on timestamp, class, or location hash, etc.). For example, the processor 110 may assign a second identifier corresponding to the first identifier to a bounding box (e.g., to maintain identity consistency between detection and tracking outputs, etc.).

For example, the processor 110 may track the bounding box by using the second identifier. For example, the processor 110 may track a target object based on identifying, in a plurality of frames, a plurality of bounding boxes including the bounding box to which the second identifier is assigned (e.g., through temporal association or object re-identification, etc.). For example, because the second identifier is an identifier assigned to the bounding box corresponding to the target object, the processor 110 may track the target object by identifying a plurality of bounding boxes, to which the second identifier is assigned, in a plurality of frames (e.g., over multiple sensor cycles or time steps, etc.).

In an example, the processor 110 may output the bounding box corresponding to the target object based on at least one of the first virtual box, the first class, the first partial points, or the second class, or any combination thereof (e.g., as a hexahedral 3D box, 2D projected box, or directional polygon, etc.). For example, a bounding box may include an example of the target object expressed in a virtual coordinate system in the form of a hexahedron (e.g., defined by eight corner points in 3D space, etc.).

Hereinafter, operations performed by a CPU, a GPU, and/or an NPU included in the processor 110 are briefly described.

In an example, the processor 110 may include at least one of the CPU, the GPU, or the NPU, or any combination thereof.

For example, at least one of the GPU, or the NPU, or any combination thereof may obtain the first virtual box and the first class based on the first neural network model (e.g., a region proposal network, transformer-based model, or YOLO-like detector, etc.). For example, at least one of the GPU or the NPU may obtain the first virtual box and the first class.

For example, at least one of the GPU, or the NPU, or any combination thereof may obtain a score for each of the plurality of points and a partial class for obtaining the second class based on the second neural network model. For example, at least one of the GPU or the NPU may obtain the score of each of the plurality of points and the partial class for obtaining the second class based on the second neural network model (e.g., probability distributions over semantic labels, etc.).

For example, the CPU may classify the second partial points corresponding to a specified type among the plurality of points based on performing the first specified algorithm for classifying the type of each of the plurality of points on the plurality of points (e.g., such as distinguishing ground, non-ground, or noise points, etc.).

As described above, the vehicle control apparatus 100 according to an example may include at least one processor 110. The vehicle control apparatus 100 may accurately detect the target object by detecting the target object by using the at least one processor 110. Furthermore, the vehicle control apparatus 100 may reduce the load on each processor by performing parallel processes (e.g., enabling real-time LiDAR segmentation and object tracking, etc.).

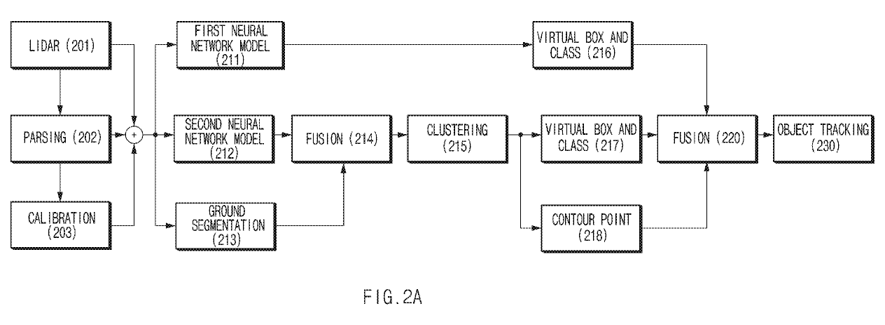

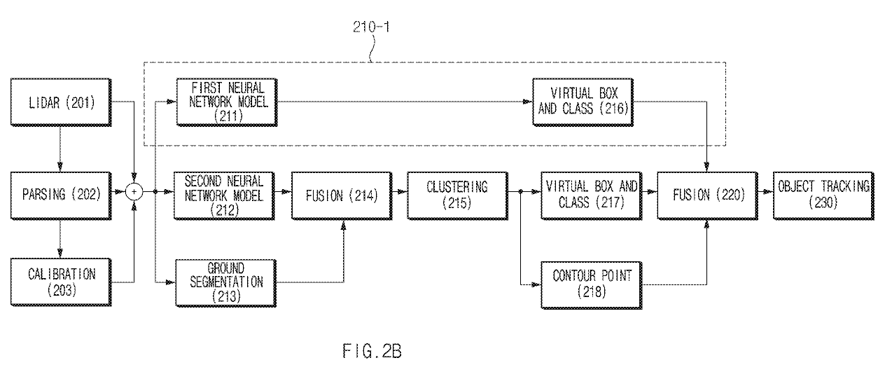

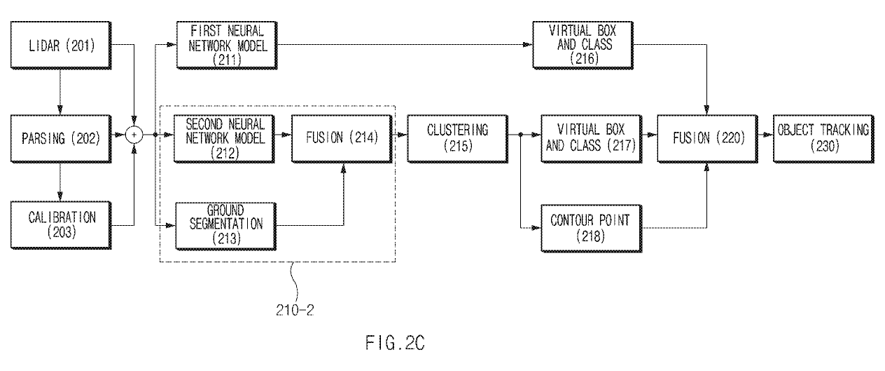

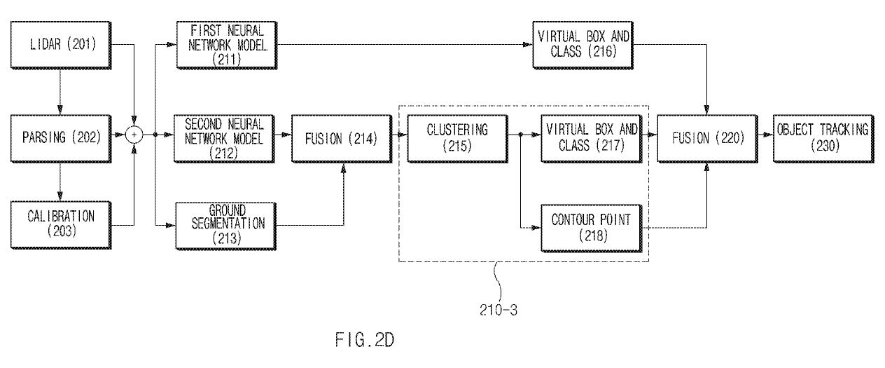

FIGS. 2A, 2B, F2C, and 2D illustrate examples of block diagrams associated with a process of a vehicle control apparatus, according to an example of the present disclosure.

The content described in FIGS. 2A, 2B, 2C, and 2D may be performed by the vehicle control apparatus 100 of FIG. 1 and/or the processor 110 included in the vehicle control apparatus 100 of FIG. 1.

Referring to FIGS. 2A, 2B, 2C, and 2D, a vehicle control apparatus according to an example may include a LiDAR 201. For example, the LiDAR 201 may include the LiDAR 120 of FIG. 1.

For example, the processor of the vehicle control apparatus may obtain packet data through the LiDAR 201 (e.g., raw distance measurements, intensity values, timestamps, or return waveforms, etc.). For example, the processor may perform parsing 202 on the packet data obtained through the LiDAR 201 (e.g., filtering noise, arranging data sequences, or extracting metadata, etc.). For example, the parsing 202 may include converting the packet data into point cloud data expressed in a sensor coordinate system (e.g., LiDAR coordinate system, radar coordinate system, or camera coordinate system, etc.).

For example, the processor may perform calibration 203 based on performing the parsing 202 (e.g., applying geometric correction, adjusting time synchronization, or correcting range bias, etc.). For example, the calibration 203 may include converting the point cloud data expressed in the sensor coordinate system to a vehicle coordinate system (e.g., world coordinate system, road coordinate system, or map coordinate system, etc.).

For example, based on performing the parsing 202 and/or the calibration 203 on a plurality of points obtained from the LiDAR 201, the processor may perform various operations on the basis of a first neural network model 211, a second neural network model 212, and/or ground segmentation 213 (e.g., object detection, terrain recognition, obstacle boundary detection, or lane marking identification, etc.).

For example, the processor may obtain a virtual box and class 216 by using the first neural network model 211 (e.g., detecting a vehicle, pedestrian, cyclist, or traffic cone, etc.). For example, the virtual box and class 216 may include the first virtual box and the first class described in FIG. 1.

For example, the processor may perform fusion 214 based on the second neural network model 212 and the ground segmentation 213 (e.g., combining results for road edges, curbs, drivable areas, or sidewalks, etc.). The content of performing the fusion 214 based on the second neural network model 212 and the ground segmentation 213 is described later in FIG. 2C.

For example, the processor may perform clustering 215 based on performing the fusion 214 (e.g., grouping points by proximity, similarity, density, or connectivity, etc.). For example, the processor may perform the clustering 215 based on performing the fusion 214 on data output from the second neural network model 212 and data based on the ground segmentation 213.

For example, the processor may obtain a virtual box and class 217 based on performing the clustering 215 (e.g., bounding boxes for cars, trucks, motorcycles, or pedestrians, etc.). For example, the virtual box and class 217 may include the second virtual box and the second class described in FIG. 1.

For example, the processor may obtain a point cloud based on performing the clustering 215 (e.g., assigning identifiers to points representing vehicles, pedestrians, traffic signs, or trees, etc.). For example, the processor may obtain the point cloud by assigning the same identifier to a plurality of points including similar characteristics.

For example, the processor may obtain a contour point 218 based on performing the clustering 215 (e.g., outlining vehicles, marking pedestrian boundaries, or detecting edges of infrastructure, etc.). For example, the contour point 218 may be identified in each of layers formed based on a z-axis among an x-axis, a y-axis, and the z-axis included in a virtual coordinate system.

For example, the contour point 218 may be obtained based on representative points, which are included in the point cloud, on each of layers formed based on the z-axis among the x-axis, the y-axis, and the z-axis. For example, the representative points may include all or part of points outside a center point among a plurality of points included in the point cloud (e.g., corner points, boundary points, or extreme points, etc.). For example, the point cloud may be obtained by performing the clustering 215 based on each of the plurality of points obtained by the LiDAR 201 being identified at a specific distance (e.g., 10 meters, 50 meters, 100 meters, or 200 meters, etc.).

For example, the processor may perform fusion 220 on the virtual box and class 216, the virtual box and class 217, and/or the contour point 218 (e.g., merging overlapping boxes, resolving conflicts, or averaging results, etc.). For example, the processor may obtain a bounding box corresponding to a target object based on performing the fusion 220.

For example, the processor may assign an identifier to the bounding box (e.g., ID-1, ID-2, ID-3, or ID-N, etc.). For example, the processor may track the target object by using the bounding box, to which the same identifier is assigned in each of a plurality of frames, by assigning the same identifier to a bounding box corresponding to a specific target object in each of the plurality of frames. For example, the processor may perform object tracking 230, which tracks a target object by using the bounding box to which the same identifier is assigned in the plurality of frames (e.g., a moving car, a crossing pedestrian, a bicycle, or an animal, etc.).

Hereinafter, in FIGS. 2B, 2C, and 2D, a first process 210-1 using the first neural network model 211, a second process 210-2 using the second neural network model 212 and the ground segmentation 213, and a third process 210-3 performing the clustering 215 are described below.

Referring to FIG. 2B, a processor (e.g., the processor 110 of FIG. 1) of a vehicle control apparatus (e.g., the vehicle control apparatus 100 of FIG. 1) according to an example of the present disclosure may obtain the virtual box and class 216 by using the first neural network model 211 in the first process 210-1 (e.g., detecting a car, a pedestrian, a bicycle, or a traffic cone, etc.).

For example, the processor may obtain the virtual box and class 216 based on inputting LiDAR data obtained by the LiDAR 201 into the first neural network model 211. For example, the LiDAR data may be obtained by the LiDAR 201, and may include data obtained by converting a plurality of points expressed in a LiDAR coordinate system to a plurality of points expressed in a vehicle coordinate system (e.g., via homogeneous transformation, rotation matrix, or translation vector, etc.). For example, the first neural network model 211 may be an object detection model, and may include a neural network model that detects an object by using a window (e.g., sliding window, region proposal, or anchor box, etc.). However, an example of the present disclosure is not limited to the above description.

For example, the processor may identify dynamic objects and/or static objects by obtaining the virtual box and class 216 based on inputting the LiDAR data to the first neural network model 211 (e.g., moving cars, walking pedestrians, parked vehicles, or roadside poles, etc.). For example, the virtual box and class 216 may be referred to as deep learning-based virtual box and class recognition results.

Referring to FIG. 2C, a processor (e.g., the processor 110 of FIG. 1) of a vehicle control apparatus (e.g., the vehicle control apparatus 100 of FIG. 1) according to an example of the present disclosure may perform the second process 210-2 using the second neural network model 212 and the ground segmentation 213 (e.g., separating road surfaces, sidewalks, curbs, or terrain boundaries, etc.).

For example, the processor may input the LiDAR data into the second neural network model 212 (e.g., raw point cloud, pre-processed frames, or sensor-fused inputs, etc.). For example, the processor may apply an algorithm associated with the ground segmentation 213 to the LiDAR data (e.g., plane fitting, RANSAC, or elevation mapping, etc.). For example, the second neural network model 212 may include a neural network model associated with segmentation (e.g., semantic segmentation, instance segmentation, or range-view segmentation, etc.).

For example, the processor may obtain result data based on inputting the LiDAR data to the second neural network model 212. For example, the result data may include a class and/or a score of each of a plurality of points (e.g., car, pedestrian, cyclist, or background, etc.). For example, the score may represent the degree to which a class of each of the plurality of points is accurate (e.g., probability 0.95, confidence level, or likelihood ratio, etc.).

For example, the processor may classify at least one point corresponding to the ground by applying an algorithm associated with the ground segmentation 213 to the LiDAR data (e.g., distinguishing asphalt, concrete, gravel, or grass, etc.).

For example, the processor may obtain points corresponding to an external object including the target object based on performing the fusion 214 on the result data output from the second neural network model 212, and at least one point corresponding to the ground obtained by the algorithm associated with the ground segmentation 213 (e.g., vehicle, pole, guardrail, or building wall, etc.).

For example, the processor may identify points in the LiDAR data, other than at least one point corresponding to the ground, based on classifying at least one point corresponding to the ground. For example, except for the at least one point corresponding to the ground, the remaining points may include points corresponding to an external object including the target object (e.g., truck, pedestrian, traffic sign, or vegetation, etc.). The above-described content may be content of performing the fusion 214. For example, the processor may obtain result data based on the fusion 214 (e.g., a refined point cloud, weighted scores, or merged features, etc.). For example, the result data may include all or part of a plurality of points obtained via the LiDAR 201, and may include a score for each of the plurality of points.

Referring to FIG. 2D, a processor (e.g., the processor 110 of FIG. 1) of a vehicle control apparatus (e.g., the vehicle control apparatus 100 of FIG. 1) according to an example of the present disclosure may perform the third process 210-3 including an operation of performing the clustering 215 (e.g., density-based clustering, k-means, or hierarchical grouping, etc.).

For example, the processor may perform the clustering 215 based on a score and result data obtained by performing the fusion 214 (e.g., grouping high-confidence pedestrian points, vehicle points, or background points, etc.). For example, the processor may group all or some of the plurality of points by performing the clustering 215 (e.g., into clusters for cars, motorcycles, bicycles, or buses, etc.).

For example, the processor may perform the clustering 215 that groups all or some of the plurality of points. The processor may obtain the virtual box and class 217 based on performing the clustering 215 (e.g., generating a bounding box for a car, pedestrian, cyclist, or obstacle, etc.). The processor may obtain the contour point 218 based on performing the clustering 215 (e.g., corner points of vehicles, outline points of pedestrians, or edge points of road barriers, etc.).

For example, the processor may assign an identifier to a virtual box (e.g., ID-1 for a vehicle, ID-2 for a pedestrian, ID-3 for a cyclist, or ID-4 for a signpost, etc.). For example, the identifier assigned to a virtual box may be identically assigned to a bounding box generated by the fusion 220.

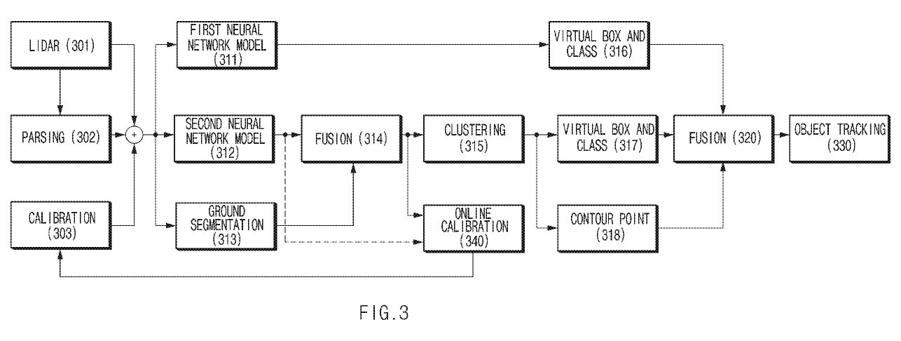

FIG. 3 shows an example of a block diagram related to a process of a vehicle control apparatus, according to an example of the present disclosure (e.g., showing data parsing, neural network inference, fusion, or clustering, etc.).

Referring to FIG. 3, a processor (e.g., the processor 110 of FIG. 1) of a vehicle control apparatus (e.g., the vehicle control apparatus 100 of FIG. 1) according to one example may perform processes substantially the same as those described in FIGS. 2A, 2B, 2C, and 2D (e.g., parsing, calibration, segmentation, or tracking, etc.).

For example, the processor may perform parsing 302 and/or calibration 303 on LiDAR data obtained via a LiDAR 301.

For example, the processor may obtain a virtual box and class 316 based on a first neural network model 311 (e.g., detecting vehicles, pedestrians, bicycles, or traffic cones, etc.).

For example, the processor may perform fusion 314 based on performing a second neural network model 312 and/or a ground segmentation 313 (e.g., combining road surface points, lane markers, sidewalks, or curbs, etc.). For example, the processor may perform clustering 315 and/or online calibration 340 based on performing the fusion 314 (e.g., grouping objects, refining boundaries, or adjusting calibration parameters, etc.).

For example, the processor may obtain a virtual box and class 317 and/or a contour point 318 based on performing the clustering 315 (e.g., bounding boxes for trucks, motorcycles, bicycles, or pedestrians, etc.).

For example, the processor may perform fusion 320 based on the virtual box and class 316, the virtual box and class 317, and/or the contour point 318 (e.g., merging results, averaging scores, or resolving overlaps, etc.). For example, the processor may perform object tracking 330 based on performing the fusion 320. For example, the object tracking 330 may include an operation of continuously tracking a target object in a plurality of frames (e.g., a moving car, a walking pedestrian, or a crossing bicycle, etc.).

In an example, the processor may perform online calibration 340. For example, the online calibration 340 may include an operation of recognizing misalignment of the LiDAR 301 and correcting a calibration parameter in real time (e.g., correcting pitch, yaw, roll, or time delay, etc.).

For example, the GPU and/or NPU may perform the online calibration 340 based on performing the fusion 314 (e.g., executing parallel matrix operations or neural network computations, etc.). For example, the CPU may perform the online calibration 340 by using result data output from the second neural network model 312 (e.g., segmentation outputs, feature maps, or probability scores, etc.).

For example, the processor may perform the online calibration 340 when a frame is obtained (e.g., every 100 ms, 50 ms, or 10 ms, etc.). For example, the processor may perform the online calibration 340 based on a specified period. For example, the specified period may be set based on a frame (e.g., every 2nd, 5th, or 10th frame, etc.). For example, the specified period may be set based on time (e.g., once per second, once per minute, or once per hour, etc.).

As described above, the processor of the vehicle control apparatus according to an example may provide assistance in obtaining highly reliable data by performing the online calibration 340 based on a specified cycle (e.g., adaptive cycle based on temperature drift, vibration level, or road condition, etc.).

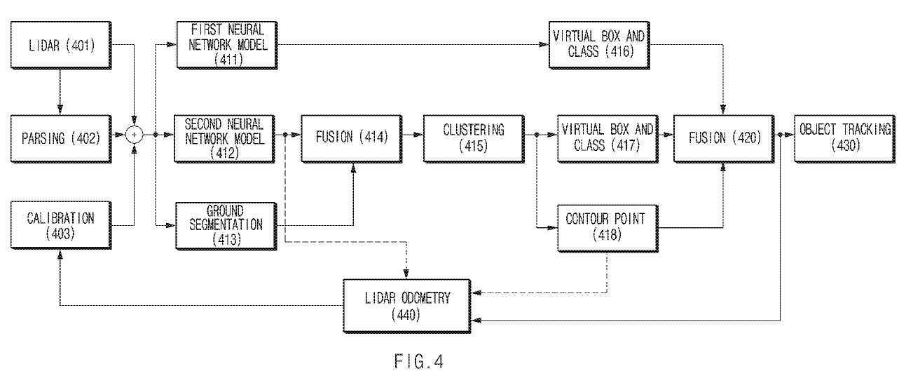

FIG. 4 shows an example of a block diagram related to a process of a vehicle control apparatus, according to an example of the present disclosure (e.g., including parsing, fusion, object tracking, or odometry, etc.).

Referring to FIG. 4, a processor (e.g., the processor 110 of FIG. 1) of a vehicle control apparatus (e.g., the vehicle control apparatus 100 of FIG. 1) according to one example may perform processes substantially the same as those described in FIGS. 2A, 2B, 2D, and 2D (e.g., parsing, segmentation, clustering, or calibration, etc.).

For example, the processor may perform parsing 402 on LiDAR data obtained via a LiDAR 401 (e.g., filtering noise, adjusting timestamps, or organizing packets, etc.).

For example, the processor may obtain a virtual box and class 416 based on a first neural network model 411 (e.g., detecting cars, buses, pedestrians, or bicycles, etc.).

For example, the processor may perform fusion 414 based on performing a second neural network model 412 and/or a ground segmentation 413 (e.g., segmenting drivable areas, sidewalks, medians, or vegetation, etc.).

For example, the processor may obtain a virtual box and class 417 and/or a contour point 418 based on performing the clustering 415 (e.g., outline of vehicles, edges of pedestrians, or perimeters of obstacles, etc.).

For example, the processor may perform fusion 420 based on the virtual box and class 416, the virtual box and class 417, and/or the contour point 418 (e.g., combining detections, refining shapes, or validating overlaps, etc.). For example, the processor may perform object tracking 430 based on performing the fusion 420. For example, the object tracking 430 may include an operation of continuously tracking a target object in a plurality of frames (e.g., a passing car, a running pedestrian, or a moving motorcycle, etc.).

In an example, the processor may generate LiDAR odometry 440 based on a dynamic point and/or a static point acquired by the fusion 420 (e.g., motion vectors of vehicles, stable landmarks, or stationary poles, etc.). In an example, the processor may generate the LiDAR odometry 440 by using result data output from the second neural network model 412 (e.g., segmentation of moving versus non-moving objects, etc.). In an example, the processor may generate the LiDAR odometry 440 based on the contour points 418 (e.g., edges of buildings, outlines of barriers, or vehicle shapes, etc.).

For example, the dynamic point and/or the static point may include a point corresponding to at least part of a target object (e.g., roof points of cars, legs of pedestrians, or handlebars of bicycles, etc.). The dynamic point and/or the static point may be referred to as a “dynamic point” when the target object is a dynamic object, or may be referred to as a “static point” when the target object is a static object (e.g., parked vehicles, road signs, or trees, etc.).

For example, the processor may generate the LiDAR odometry 440 based on the result data output from the second neural network model 412 and/or the contour point 418 (e.g., matching features across frames, estimating displacement, or updating trajectories, etc.).

In an example, the processor may perform calibration 403 by using the LiDAR odometry 440 based on generating the LiDAR odometry 440. For example, the LiDAR odometry 440 may include data obtained by calculating changes in the position of a vehicle equipped with the LiDAR 401 (e.g., translation, rotation, or velocity changes, etc.).

As described above, the processor of the vehicle control apparatus according to an example may provide the effect of accurately performing object tracking 430 by performing calibration 403 by using the LiDAR odometry 440 (e.g., reducing drift error, improving accuracy, or enhancing stability, etc.).

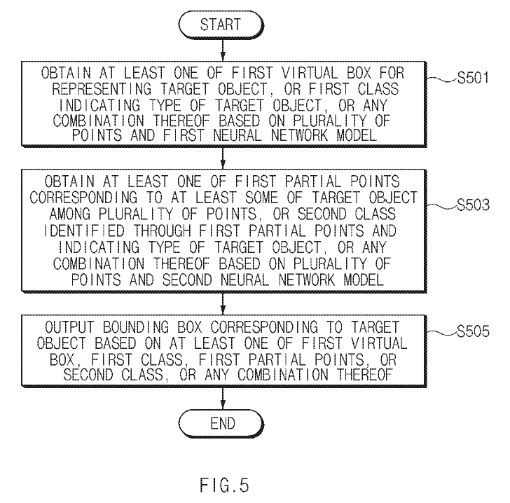

FIG. 5 shows an example of a flowchart associated with a vehicle control method, according to an example of the present disclosure (e.g., illustrating parsing, classification, fusion, clustering, or tracking steps, etc.).

Hereinafter, it is assumed that the vehicle control apparatus 100 of FIG. 1 performs the process of FIG. 5. In addition, in a description of FIG. 5, it may be understood that an operation described as being performed by an apparatus is controlled by the processor 110 of the vehicle control apparatus 100 (e.g., executing software instructions, running neural network models, or coordinating sensor inputs, etc.).

At least one of operations of FIG. 5 may be performed by the vehicle control apparatus 100 of FIG. 1. At least one of operations of FIG. 5 may be performed by the processor 110 of FIG. 1. Each of the operations in FIG. 5 may be performed sequentially, but is not necessarily sequentially performed. For example, the order of operations may be changed, and at least two operations may be performed in parallel (e.g., parsing and calibration, clustering and tracking, or segmentation and fusion, etc.).

Referring to FIG. 5, in S501, a vehicle control method according to an example may include an operation of obtaining at least one of a first virtual box for representing a target object, or a first class indicating the type of the target object, or any combination thereof based on the plurality of points and the first neural network model (e.g., detecting a car, a pedestrian, a bicycle, or a traffic sign, etc.).

In S503, the vehicle control method according to an example may include an operation of obtaining at least one of first partial points corresponding to at least some of the target object among the plurality of points, or a second class identified through the first partial points and indicating the type of the target object, or any combination thereof based on the plurality of points and a second neural network model (e.g., partial points for vehicle edges, pedestrian legs, or cyclist handlebars, etc.).

For example, the vehicle control method according to an example may include an operation of classifying the second partial points corresponding to a specified type among the plurality of points based on performing the first specified algorithm for classifying the type of each of the plurality of points on the plurality of points. For example, the first specified algorithm may include an algorithm associated with ground segmentation (e.g., plane fitting, RANSAC, or elevation mapping, etc.). For example, the specified type may include a type indicating the ground (e.g., asphalt, concrete, grass, or gravel, etc.).

For example, the vehicle control method may include an operation of identifying first partial points based on classifying second partial points (e.g., separating vehicle points from ground points, or distinguishing pedestrian points from road surface points, etc.).

For example, the vehicle control method may include an operation of obtaining a score of each of a plurality of points, and a partial class for obtaining a second class based on inputting a plurality of points into a second neural network model (e.g., assigning 0.9 confidence to “car,” 0.7 confidence to “pedestrian,” or 0.6 confidence to “cyclist,” etc.).

For example, the vehicle control method may include an operation of fusing the partial class, the score of each of the plurality of points, and second partial points (e.g., combining probability maps, merging class outputs, or weighting scores, etc.).

In S505, the vehicle control method according to an example may include an operation of outputting a bounding box corresponding to the target object based on at least one of the first virtual box, the first class, the first partial points, or the second class, or any combination thereof (e.g., generating a rectangular box around a car, pedestrian, cyclist, or animal, etc.).

According to an example, the vehicle control method may include an operation of controlling a host vehicle including the vehicle control apparatus based on the bounding box. For example, the vehicle control method may include an operation of generating a route for avoiding a target object corresponding to the bounding box based on the bounding box, and driving the host vehicle based on the generated route (e.g., braking to stop, steering to bypass, or accelerating to overtake, etc.). However, an example of the present disclosure is not limited to the above description.

The vehicle control method according to an example may include an operation of obtaining a point cloud for generating a second virtual box based on the first partial points. For example, the point cloud may include a set of points obtained by grouping the first partial points (e.g., points belonging to vehicle edges, pedestrian contours, or bicycle frames, etc.).

For example, the vehicle control method may include an operation of generating the second virtual box, which is different from the first virtual box and represents the target object, based on the point cloud. For example, the second virtual box may include a hexahedral box including all or part of the point cloud (e.g., enclosing a bus, a truck, or a pedestrian cluster, etc.).

According to an example, the vehicle control method may include an operation of identifying at least one of a heading direction indicating a traveling direction of the target object, a location of the second virtual box in a virtual coordinate system, a size of the second virtual box, or the second class, or any combination thereof based on at least one of the first partial points, or the point cloud, or any combination thereof (e.g., heading east, size 2m × 1m × 1.5m, or classified as a car, etc.).

According to an example, the vehicle control method may include an operation of obtaining at least one of the heading direction of the bounding box, the location of the bounding box in the virtual coordinate system, or the third class indicating the type of the target object corresponding to the bounding box, or any combination thereof based on at least one of the first virtual box, the first class, the heading direction of the second virtual box, the location of the second virtual box, the size of the second virtual box, or the second class, or any combination thereof (e.g., bounding box heading north, located at coordinates (x,y,z), or classified as a pedestrian, etc.).

According to an example, the vehicle control method may include an operation of assigning, to the second virtual box, a first identifier for tracking the second virtual box (e.g., ID-101, ID-202, or ID-303, etc.).

For example, the vehicle control method may include an operation of assigning a second identifier corresponding to a first identifier to the bounding box. For example, the first identifier and second identifier may be the same identifier (e.g., same ID used across frames for consistent tracking, etc.).

According to an example, the vehicle control method may include an operation of tracking a target object based on identifying, in a plurality of frames, a plurality of bounding boxes including the bounding box to which the second identifier is assigned (e.g., tracking a car across 10 frames, a pedestrian across 20 frames, or a bicycle across 15 frames, etc.).

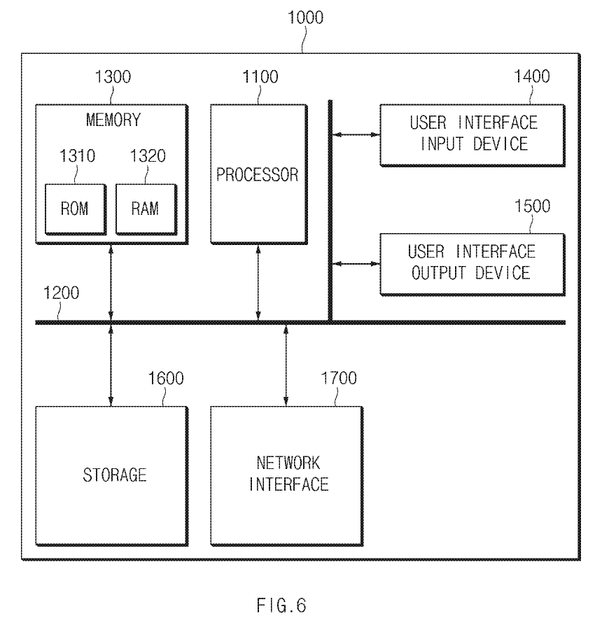

FIG. 6 shows an example computing system associated with a vehicle control apparatus or vehicle control method, according to an example of the present disclosure.

Referring to FIG. 6, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600 (e.g., microprocessor, microcontroller, or system-on-chip, etc.). Each of the memory 1300 and the storage 1600 may include various types of volatile or nonvolatile storage media. For example, the memory 1300 may include a read only memory (ROM) and a random access memory (RAM) (e.g., SRAM, DRAM, or LPDDR, etc.).

Accordingly, the operations of the method or algorithm described in connection with the examples disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM) (e.g., USB drive, solid state drive, or Blu-ray disc, etc.).

The storage medium may be coupled to the processor 1100. The processor 1100 may read out information from the storage medium and may write information in the storage medium (e.g., configuration data, neural network weights, or calibration parameters, etc.). Alternatively, the storage medium may be integrated with the processor 1100. The processor and storage medium may be implemented with an application specific integrated circuit (ASIC) (e.g., designed for autonomous driving, vision processing, or LiDAR signal processing, etc.). The ASIC may be provided in a user terminal. Alternatively, the processor and storage medium may be implemented with separate components in the user terminal (e.g., standalone CPU with external DRAM, or FPGA with off-chip flash, etc.).

An example of the present disclosure provides a vehicle control apparatus for tracking an object by using LiDAR data obtained from LiDAR, and a method thereof.

An example of the present disclosure provides a vehicle control apparatus for reducing a load on at least one processor by performing data processing on the LiDAR data by using the at least one processor, and a method thereof.

An example of the present disclosure provides a vehicle control apparatus for reducing the type, location, attitude, vehicle type, and/or vehicle-specific location dependency of a sensor by calibrating the LiDAR data, and a method thereof.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, a vehicle control apparatus includes a light detection and ranging (LiDAR) that obtains a plurality of points based on a pulsed laser signal, a memory that stores a first neural network model for detecting an object, and a second neural network model for outputting types of the plurality of points and scores of the plurality of points, and at least one processor. The at least one processor obtains at least one of a first virtual box for representing a target object, or a first class for indicating a type of the target object, or any combination thereof based on the plurality of points and the first neural network model, obtains at least one of first partial points corresponding to at least some of the target object among the plurality of points, or a second class identified through the first partial points and indicating the type of the target object, or any combination thereof based on the plurality of points and the second neural network model, and outputs a bounding box corresponding to the target object based on at least one of the first virtual box, the first class, the first partial points, or the second class, or any combination thereof.

In an example, the at least one processor may classify second partial points corresponding to a specified type among the plurality of points based on performing a first specified algorithm for classifying a type of each of the plurality of points on the plurality of points, and may identify the first partial points based on classifying the second partial points.

In an example, the at least one processor may obtain a partial class for obtaining the second class, and a score of each of the plurality of points based on inputting the plurality of points to the second neural network model, and may fuse the partial class, the score of each of the plurality of points, and the second partial points.

In an example, the at least one processor may obtain a point cloud for generating a second virtual box based on the first partial points; and may generate a second virtual box, which is different from the first virtual box and represents the target object, based on the point cloud.

In an example, the at least one processor may identify at least one of a heading direction indicating a traveling direction of the target object, a location of the second virtual box in a virtual coordinate system, a size of the second virtual box, or the second class, or any combination thereof based on at least one of the first partial points, or the point cloud, or any combination thereof.

In an example, the at least one processor may obtain at least one of a heading direction of the bounding box, the location of the bounding box in the virtual coordinate system, or the third class indicating the type of the target object corresponding to the bounding box, or any combination thereof based on at least one of the first virtual box, the first class, a heading direction of the second virtual box, the location of the second virtual box, the size of the second virtual box, or the second class, or any combination thereof.

In an example, the at least one processor may assign a first identifier for tracking the second virtual box to the second virtual box.

In an example, the at least one processor may assign a second identifier corresponding to the first identifier to the bounding box.

In an example, the at least one processor may track the target object based on identifying a plurality of bounding boxes including the bounding box, to which the second identifier is assigned, in a plurality of frames.

In an example, the at least one processor may include at least one of a central processing unit (CPU), a graphics processing unit (GPU), or a neural processing unit (NPU), or any combination thereof.

In an example, at least one of the GPU or the NPU may obtain the first virtual box and the first class based on the first neural network model.

In an example, at least one of the GPU or the NPU may obtain a partial class for obtaining the second class, and a score of each of the plurality of points based on the second neural network model.

In an example, the CPU may classify second partial points corresponding to a specified type among the plurality of points based on performing a first specified algorithm for classifying a type of each of the plurality of points on the plurality of points.

In an example, the at least one processor may generate odometry associated with the LiDAR based on generating the bounding box, and may calibrate the plurality of points by using the odometry.

In an example, the at least one processor may perform online calibration based on obtaining the first partial points; and may calibrate the plurality of points based on performing the online calibration.

According to an example of the present disclosure, a vehicle control method includes obtaining, by at least one processor, at least one of a first virtual box for representing a target object, or a first class for indicating a type of the target object, or any combination thereof based on a first neural network model and a plurality of points obtained through a LiDAR, obtaining, by the at least one processor, at least one of first partial points corresponding to at least some of the target object among the plurality of points, or a second class identified through the first partial points and indicating the type of the target object, or any combination thereof based on the plurality of points and a second neural network model, and outputting, by the at least one processor, a bounding box corresponding to the target object based on at least one of the first virtual box, the first class, the first partial points, or the second class, or any combination thereof.

According to an example, the vehicle control method may further include classifying second partial points corresponding to a specified type among the plurality of points based on performing a first specified algorithm for classifying a type of each of the plurality of points on the plurality of points, and identifying the first partial points based on classifying the second partial points.

According to an example, the vehicle control method may further include obtaining a partial class for obtaining the second class, and a score of each of the plurality of points based on inputting the plurality of points to the second neural network model, and fusing the partial class, the score of each of the plurality of points, and the second partial points.

According to an example, the vehicle control method may further include obtaining a point cloud for generating a second virtual box based on the first partial points, and generating a second virtual box, which is different from the first virtual box and represents the target object, based on the point cloud.

According to an example, the vehicle control method may further include identifying at least one of a heading direction indicating a traveling direction of the target object, a location of the second virtual box in a virtual coordinate system, a size of the second virtual box, or the second class, or any combination thereof based on at least one of the first partial points, or the point cloud, or any combination thereof.

The above description is merely an example of the technical idea of the present disclosure, and various modifications and variations may be made by one skilled in the art without departing from the essential characteristic of the present disclosure.

Accordingly, examples of the present disclosure are intended not to limit but to explain the technical idea of the present disclosure, and the scope and spirit of the present disclosure is not limited by the above examples. The scope of protection of the present disclosure should be construed by the attached claims, and all equivalents thereof should be construed as being included within the scope of the present disclosure.

The present technology may track an object by using LiDAR data obtained from LiDAR.

Moreover, the present technology may reduce a load on at least one processor by performing data processing on the LiDAR data by using the at least one processor.

Moreover, the present technology may reduce the type, location, attitude, vehicle type, and/or vehicle-specific location dependency of a sensor by calibrating the LiDAR data.

Besides, a variety of effects directly or indirectly understood through the present disclosure may be provided.

Hereinabove, although the present disclosure was described with reference to examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus of a vehicle, the apparatus comprising:
a sensor configured to, based on a pulsed laser signal emitted from the sensor, obtain a plurality of points associated with surroundings of the vehicle;
a memory configured to store:
a first neural network model for detecting an object, and
a second neural network model for outputting types of the plurality of points and scores of the plurality of points; and
a processor circuit configured to:
based on the plurality of points and the first neural network model, obtain at least one of:
a first virtual box for representing a target object in the surroundings of the vehicle, or
a first class for indicating a type of the target object,
based on the plurality of points and the second neural network model, obtain at least one of:
first partial points among the plurality of points, wherein the first partial points correspond to at least part of the target object, or
a second class identified based on the first partial points, wherein the second class indicates the type of the target object,
based on at least one of the first virtual box, the first class, the first partial points, or the second class, output a signal indicating a bounding box, wherein the bounding box corresponds to the target object, and
control, based on the bounding box, autonomous driving of the vehicle.

2. The apparatus of claim 1, wherein the processor circuit is configured to:
based on classifying a type of each of the plurality of points, classify second partial points among the plurality of points, wherein the second partial points correspond to a preset type, and
identify, based on the classifying of the second partial points, the first partial points.

3. The apparatus of claim 2, wherein the processor circuit is configured to:
based on processing the plurality of points using the second neural network model, obtain a partial class for obtaining the second class, and obtain a score of each of the plurality of points, and
fuse the partial class, the score of each of the plurality of points, and the second partial points.

4. The apparatus of claim 1, wherein the processor circuit is configured to:
obtain, based on the first partial points, a point cloud, and
generate, based on the point cloud, a second virtual box, wherein the second virtual box is different from the first virtual box and represents the target object.

5. The apparatus of claim 4, wherein the processor circuit is configured to: based on at least one of the first partial points or the point cloud,
identify at least one of:
a heading direction indicating a traveling direction of the target object,
a location of the second virtual box in a virtual coordinate system,
a size of the second virtual box, or
the second class.

6. The apparatus of claim 5, wherein the processor circuit is configured to: based on at least one of the first virtual box, the first class, a heading direction of the second virtual box, the location of the second virtual box, the size of the second virtual box, or the second class,
obtain at least one of:
a heading direction of the bounding box,
the location of the bounding box in the virtual coordinate system, or
a third class indicating the type of the target object corresponding to the bounding box.

7. The apparatus of claim 4, wherein the processor circuit is configured to:
assign a first identifier to the second virtual box, wherein the second virtual box is tracked based on the first identifier.

8. The apparatus of claim 7, wherein the processor circuit is configured to:
assign a second identifier to the bounding box, wherein the second identifier corresponds to the first identifier.

9. The apparatus of claim 8, wherein the processor circuit is configured to:
track the target object across a plurality of frames based on identifying a plurality of bounding boxes that include the bounding box assigned with the second identifier.

10. The apparatus of claim 1, wherein the processor circuit includes:
at least one of a central processing unit (CPU), a graphics processing unit (GPU), or a neural processing unit (NPU).

11. The apparatus of claim 10, wherein at least one of the GPU or the NPU is configured to:
obtain, based on the first neural network model, the first virtual box and the first class.

12. The apparatus of claim 10, wherein at least one of the GPU or the NPU is configured to:
based on the second neural network model, obtain a partial class for obtaining the second class, and obtain a score of each of the plurality of points.

13. The apparatus of claim 10, wherein the central processing circuit is configured to:
based on classifying a type of each of the plurality of points, classify second partial points among the plurality of points, wherein the second partial points correspond to a preset type.

14. The apparatus of claim 1, wherein the processor circuit is configured to:
generate, based on the bounding box, odometry associated with the sensor, and
calibrate, based on the odometry, the plurality of points.

15. The apparatus of claim 1, wherein the processor circuit is configured to:
perform, based on the first partial points, online calibration of the plurality of points.

16. A method performed by an apparatus of a vehicle, the method comprising:
obtaining, from a sensor, a plurality of points associated with surroundings of the vehicle;
based on the plurality of points and a first neural network model, obtaining at least one of:
a first virtual box for representing a target object in the surroundings of the vehicle, or
a first class for indicating a type of the target object;
based on the plurality of points and a second neural network model, obtaining at least one of:
first partial points among the plurality of points, wherein the first partial points correspond to at least part of the target object, or
a second class identified based on the first partial points, and wherein the second class indicates the type of the target object;
based on at least one of the first virtual box, the first class, the first partial points, or the second class, outputting a signal indicating a bounding box, wherein the bounding box corresponds to the target object; and
controlling, based on the signal, autonomous driving of the vehicle.

17. The method of claim 16, further comprising:
based on classifying a type of each of the plurality of points, classifying second partial points among the plurality of points, wherein the second partial points correspond to a preset type; and
identifying, based on the classifying of the second partial points, the first partial points.

18. A vehicle comprising:
a sensor configured to obtain point cloud data representing surroundings of the vehicle;
a memory configured to store a first neural network model and a second neural network model;
a driving control circuit configured to control autonomous driving of the vehicle; and
a processor circuit configured to cause the vehicle to:
obtain, based on the point cloud data and the first neural network model, a first virtual box and a first class, wherein the first virtual box and the first class are associated with a target object,
obtain, based on the point cloud data and the second neural network model, first partial points and a second class, wherein the first partial points and the second class are associated with the target object, and wherein the first partial points correspond to at least part of the target object,
generate a bounding box representing the target object based on at least one of the first virtual box, the first class, the first partial points, or the second class,
track the bounding box across a plurality of frames of the point cloud data,
calibrate the point cloud data based on the tracked bounding box and update the bounding box based on the calibrated point cloud data,
output a signal indicating the updated bounding box, and
control, via the driving control circuit and based on the signal, autonomous driving of the vehicle.

19. The vehicle of claim 18, wherein the processor circuit is configured to cause the vehicle to perform, based on misalignment of the sensor, calibration of the point cloud data during operation of the vehicle in real time.

20. The vehicle of claim 18, wherein the processor circuit is configured to cause the vehicle to distribute processing of the point cloud data among a plurality of processing circuits.
